(19) United States
(12) Patent Application Publication
(10) Pub. No.: US 2023/0091357 A1
(43) Pub. Date: Mar. 23, 2023

(54) EYEPIECES EMPLOYING POLYMERIC LAYERED GRADIENT REFRACTIVE INDEX (LGRIN) OPTICAL ELEMENTS FOR PERFORMANCE ENHANCEMENT

(71) Applicant: Peak Nano Optics LLC, Valley View, OH (US)

(72) Inventors: Howard Fein, Richmond Heights, OH (US); Richard Stanley Lepkowicz, Great Falls, VA (US)

(21) Appl. No.: 17/890,880

(22) Filed: Aug. 18, 2022

Related U.S. Application Data
(60) Provisional application No. 63/246,666, filed on Sep. 21, 2021.

(51) Int. Cl. G02B 25/00; G02B 3/00

(52) U.S. Cl. CPC G02B 25/001; G02B 3/0087

(57) ABSTRACT

The systems, devices, and methods described herein relate to eyepieces with one or more homogenous optical elements which may be configured to include one or more polymeric nanolayer gradient index (LGRIN) lenses. The one or more LGRIN lenses may replace one or more of the homogenous optical elements or be added as corrector lenses on an end of the eyepiece to provide improved optical performance of the eyepiece.

### PRIORITY

This application claims the benefit of the filing date of U.S. Provisional Application No. 63/246,666, filed Sep. 21, 2021, which is incorporated herein by reference in its entirety.

### TECHNICAL FIELD

The present disclosure is directed to a systems, devices, and methods to provide optical devices for light manipulation. More specifically, the present disclosure is directed to eyepieces employing gradient index (GRIN) lenses.

### BACKGROUND OF THE DISCLOSURE

Demand for optical eyepieces providing improved image quality requires increasingly complex optical systems. Optical eyepieces are typically used with other optics to form a complete system which may be configured for use with a human eye and/or imaging system. Optical eyepieces are used in a large variety of contexts, ranging from a simple magnifier to an integral part of a complex optical system including numerous lenses having different configurations.

The design of optical eyepieces includes the balancing of many performance characteristics, including field of view, resolution, contrast, transmission, color-correction, eye-relief, field-flatness, and weight. Typical eyepieces using homogenous lenses of glass or plastic may not be able to achieve some of these performance characteristics due to the physical properties of the lenses. For example, a complex, multi-lens telescope system used for astronomy may have physical constraints such as length and weight due to the available lenses.

Gradient Index (GRIN) lenses are more commonly being used in optical contexts. GRIN lenses include one or more inhomogeneous optical elements in which the index of refraction varies over one or more dimensions of the lens. GRIN lenses are not typically used in complex lens systems including other homogenous lenses. Therefore, needs exist for the use of GRIN lenses in optical eyepieces to improve performance and reduce weight.

### SUMMARY

In some example aspects, the present disclosure introduces an optical eyepiece, which may include one or more refractive homogenous optical elements having a single index of refraction; and one or more gradient index (GRIN) lenses having an index of refraction that varies across their volume, the one or more GRIN lenses being disposed adjacent to the one or more homogenous optical elements and configured to correct aberrations produced by the one or more homogenous optical elements; and a housing supporting the one or more homogenous optical elements and the one or more GRIN lenses.

In some implementations, the GRIN lens includes one or more of a polymeric nanolayer gradient index (LGRIN) lens, polymer/glass nanolayered lens, and polymer lens with inorganic filler in one or more layers. The one or more GRIN lenses may be configured to replace the one or more refractive homogenous optical elements. The one or more refractive homogenous optical elements and the one or more GRIN lenses may be arranged in one of a Huygens, Ramsden, Kellner, Plossl, Orthoscopic, Erfle, Scidmore, Nagler, Brandon, and Cooke lens forms. The index of refraction of the one or more GRIN lenses may vary smoothly from a first value at a first surface to a second value at a second surface. The one or more GRIN lenses physically contacts the one or more refractive homogenous optical elements. The eyepiece may be configured for use with one of a telescope, microscope, night vision device, binoculars, and heads-up display. The optical eyepiece may include an optical sensor within the housing, the optical sensor configured to receive light rays passing through the one or more refractive homogenous optical elements and the one or more GRIN lenses.

Example methods for forming and using optical eyepieces are also provided. In some implementations, these method include steps of: providing a plurality of refractive optical elements along an optical axis, the plurality of refractive optical elements including a first optical element and a second optical element, the first optical element and the second optical element being homogenous and having single indices of refraction; replacing the first optical element with a gradient index (GRIN) lens having an index of refraction that varies across its volume, the GRIN lens being disposed adjacent to the second optical element along the optical axis, the GRIN lens being configured to correct aberrations produced by the second optical element; and passing light rays through the optical eyepiece.

In some implementations, the GRIN lens is a polymeric nanolayer gradient index (LGRIN) lens or a layered polymeric/inorganic composite structure. The plurality of refractive optical elements may be arranged in one of a Huygens, Ramsden, Kellner, Plossl, Orthoscopic, Effie, Scidmore, Nagler, Brandon, and Cooke lens form. The index of refraction of the GRIN lens may vary smoothly from a first value at a first surface to a second value at a second surface. The GRIN lens may be positioned to physically contact the second optical element. The eyepiece may be configured for use with one of a telescope, microscope, night vision device, binoculars, and heads-up display. The method may include comprising positioning an optical sensor configured to receive light rays passing through the GRIN lens and second optical element.

Example optical eyepieces are also provided. These example optical eyepieces may include: a plurality of refractive optical elements arranged along an optical axis from an object side to an image side, the plurality of refractive optical elements including: one or more homogenous lenses having a single index of refraction; and one or more polymeric nanolayer gradient index (LGRIN) lenses each having an index of refraction that varies across its volume, the one or more LGRIN lenses being positioned on the object side of the one or more homogenous lenses and configured to correct aberrations produced by the one or more homogenous lenses; and a housing sized to accommodate the plurality of refractive optical elements, the plurality of refractive optical elements being mounted within the housing.

In some implementations, the plurality of refractive optical elements is arranged in one of a Huygens, Ramsden, Kellner, Plossl, Orthoscopic, Erfle, Scidmore, Nagler, Brandon, and Cooke lens form. The index of refraction of the one or more LGRIN lenses may vary smoothly from a first value at a first surface to a second value at a second surface. The eyepiece may be configured for use with one of a telescope, microscope, night vision device, binoculars, Augmented Reality, Virtual Reality, and heads-up display. The optical eyepiece may also include an optical sensor configured to receive light rays passing through the optical eyepiece.

Example methods for forming and using an optical eyepiece are also provided. These methods may include steps of: providing a plurality of refractive optical elements along an optical axis, the plurality of refractive optical elements including a first optical element and a second optical element, the first optical element and the second optical element being homogenous and having single indices of refraction; providing a gradient index (GRIN) lens having an index of refraction that varies across its volume as a corrector, the GRIN lens being disposed adjacent to the second optical element along the optical axis, the GRIN lens being configured to correct aberrations produced by the first and second optical elements; and passing light rays through the optical eyepiece.

In some implementations, the GRIN lens is a polymeric nanolayer gradient index (LGRIN) lens or a layered polymeric/inorganic composite structure. The plurality of refractive optical elements may be arranged in one of a Huygens, Ramsden, Kellner, Plossl, Orthoscopic, Erfle, Scidmore, Nagler, Brandon, and Cooke lens form. The plurality of refractive optical elements may be incorporated in an athermalized lens design.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a diagram of three portions of optical material as known in the art.

FIG. 2A is a diagram of a portion of optical material as known in the art.

FIG. 2B is a diagram of an index of refraction of the portion of optical material in FIG. 2A having a first profile as known in the art.

FIG. 3A is a diagram showing various example conventional eyepieces that are suitable for use with one or more LGRIN lenses according to one or more aspects of the present disclosure.

FIG. 3B is a diagram of a various example conventional eyepieces that are suitable for use with one or more LGRIN lenses according to one or more aspects of the present disclosure.

FIG. 4 is a diagram of a various example conventional eyepieces that are suitable for use with one or more LGRIN lenses according to one or more aspects of the present disclosure.

FIG. 5 is a diagram of a wide-angle eyepiece that is suitable for use with one or more LGRIN lenses according to one or more aspects of the present disclosure.

FIG. 6 is a diagram of two eyepieces that are suitable for use with one or more LGRIN lenses according to one or more aspects of the present disclosure.

FIG. 7 is a diagram of an eyepiece including an LGRIN lens according to one or more aspects of the present disclosure.

FIG. 8 is a is a diagram of an eyepiece including an LGRIN lens according to one or more aspects of the present disclosure.

FIG. 9A is a diagram of a binocular design with conventional lenses as known in the art.

FIG. 9B is a diagram of a binocular design including an LGRIN lens according to one or more aspects of the present invention.

FIG. 9C is a diagram of another binocular design including an LGRIN lens according to one or more aspects of the present invention.

FIG. 10A is a diagram of a lens in a heads-up system that is suitable for use with one or more LGRIN lenses according to one or more aspects of the present disclosure.

FIG. 10B is a diagram of another lens in a heads-up system that is suitable for use with one or more LGRIN lenses according to one or more aspects of the present disclosure.

FIG. 10C is a diagram of yet another lens in a heads-up system that is suitable for use with one or more LGRIN lenses according to one or more aspects of the present disclosure.

FIG. 11A is a diagram of an exemplary eyepiece.

FIG. 11B is a diagram of the exemplary eyepiece of FIG. 11A configured with an LGRIN lens.

FIG. 12A is a diagram of an exemplary eyepiece.

FIG. 12B is a diagram of the exemplary eyepiece of FIG. 12A configured with an LGRIN lens.

FIG. 13 is a flow chart of an example method of integrating one or more LGRIN lenses with an eyepiece.

### DETAILED DESCRIPTION

The systems, devices, and methods described herein relate to optical eyepieces including one or more gradient refractive index (GRIN) optics which may replace one or more conventional homogenous lenses.

It is to be understood that the following disclosure provides many different implementations, or examples, for implementing different features of various configurations. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various implementations and/or configurations discussed. Moreover, the formation of a first feature over or on a second feature in the description that follows may include implementations in which the first and second features are formed in direct contact, and may also include implementations in which additional features may be formed interposing the first and second features, such that the first and second features may not be in direct contact.

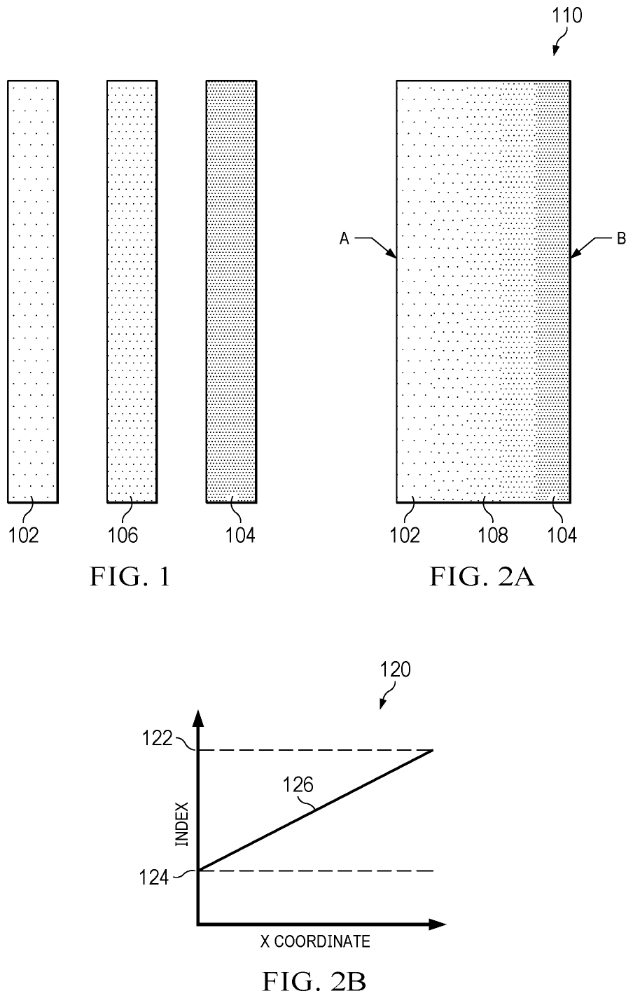

FIG. 1 is a diagram of three portions of optical material that may be used in a conventional GRIN lens as known in the art. GRIN optical elements may include a first optical material 102, a second optical material 104, and a transition 106 including a mixture of the first and second optical materials 102, 104. GRIN optical elements such as lenses may be formed using optical materials in one or more gradient portions such as the gradient portion 110 shown in FIG. 2A. For example, the gradient portion 110 (which may be part of a GRIN lens) may include a first optical material 102 at a first surface A, a second optical material 104 at a second surface B, and a transition 108 between the first optical material 102 and a second optical material 104.

Many conventional GRIN lenses include flat or nearly flat (also referred to as planar) surfaces and may minimize aberrations present in spherical lenses. FIG. 2B shows a graph 120 of the index of refraction along the x-coordinate of the gradient portion 110 of FIG. 2A. The first optical material 102 may have a first value 124 of index of refraction and the second optical material 104 may have a second value 122 of index of refraction (higher than the first index of refraction in this example). The profile 126 of the index of refraction changes gradually over the x-axis of the transition portion 110, changing from the lower value 124 of index of refraction at surface A to the higher value 122 of index of refraction at surface B. In some implementations, the profile 126 in the index of refraction includes a smooth transition including one or more linear, logarithmic, exponential, or other curved shapes. The GRIN lenses discussed herein may include any of the above profiles, and in particular, may include a transition between different index of refraction values, for example where the index of refraction varies smoothly, discontinuously, cyclically, or with other graduated change, which might also include any, or some, homogeneous part of the GRIN profile as well. In some implementations, the GRIN lenses discussed herein may include areas where the index of refraction remains the same across one or more portions of the lens, such as including a smooth transition from a first index of refraction at the object-side surface of the GRIN lens across ⅓ of the lens to a second index of refraction, and the remaining portion of the lens having the same index of refraction. In this way, GRIN lenses may include areas of transition of index of refraction that may be placed together in various configurations with portions with unchanging index of refraction. The shape of the GRIN lenses discussed herein include curved surfaces (convex and concave) as well as flat or nearly flat, and may have aspherics, freeform shapes, or diffractives on the various surfaces.

Polymeric Layered Gradient Refractive Index (LGRIN) lenses are a subset of GRIN lenses may include a number of layers with varying indices of refraction stacked together. In the following disclosure, GRIN lenses and LGRIN lenses may be used interchangeably, as the eyepieces discussed herein may be improved with GRIN lenses in general or LGRIN lenses in particular. In some embodiments, the layers of an LGRIN lens are formed from polymers and have such small thicknesses and are stacked in such great numbers that the index of refraction of the LGRIN lens transitions smoothly between values. LGRIN lenses may designed and fabricated to possess application-specific characteristics such as having one or more aspheric surfaces and particular volumetric gradient index distributions. LGRIN lenses as discussed herein may layers of plastic, layered polymeric optics with inorganic dopants or fillers, lenses made with inorganic fillers and dyes in the layers, layers formed from inorganic glasses laminated into a lens, or a mix of polymers and inorganic glass layers, as well as mixtures of any of the above. As discussed here, LGRIN lenses covers these exemplary types but is not limited to those, any and all past, or any and all currently existing, and, moreover, could have direct applicability in the same way as described to any, all, or some future and even yet undeveloped eyepiece designs which themselves might, or might not include other GRIN technologies as described herein. In some implementations, optical design for eyepieces with GRIN elements could include, but is not limited to, athermalized design and performance over and wide range of operational temperatures appropriately defined by the thermal behavior of optical and mechanical materials employed in the optical design and fabrication of such eyepieces. LGRIN lenses may be singular or multiple in use, and may be fabricated to fit within both existing optical eyepiece designs as “Correctors” and, or, be designed as other lenses which are part of entirely unique and new optical eyepiece designs, to give significantly enhanced performance compared to eyepieces which do not have LGRIN lenses. In some implementations, the LGRIN lenses discussed herein include optical material operating in the 350-2000 nm wavelength space. In other implementations, the optical materials are configured for other ranges of wavelengths, such as 400-1000 nm, 1000-2000 nm, and 100-2000 nm.

While most referential use of such eyepieces as shown herein are to astronomical telescopes, microscopes, and other imaging optical systems, this is to be understood to be to apparatuses involved alternatively in visualizing wholly, direct or real-images, virtual-images, computer-generated images, and other optically or virtually created images in which case the involved optics are merely involved in refracting and focusing images for human perception, as well as those apparatuses such as binocular, terrestrial telescope optics, “night vision goggles”, “spotting scopes”, Augmented Reality and/or Virtual Reality apparatus. In some implementations, these apparatuses both collect existing visual and near-visual wavelengths, process or “translate” them in some way, and then project them for human perception. In the latter instance, the involved LGRIN lenses may be integrated into eyepieces in their entirety, or separately, may be utilized either or both in gathering the to-be processed waves and projecting processed images to a user. Likewise, the involved LGRIN lenses may be utilized either or both in gathering the to-be processed waves and projecting processed images to an imaging device or medium (such as an electronic detector, CCD, CMOS, photographic medium, photographic film, photographic plate, for example).

Furthermore, significant advantages can be achieved by improving conventional optical systems with LGRIN technology. Through “layering”, the LGRIN optics technology offers significant and heretofore unachievable advantages, when compared to either conventional homogeneous optics or to conventional glass and plastic GRIN optics. Applying the LGRIN lens volume, i.e. subsurface material which can have Gradient Index in both axial and spherical volumetric distribution to said conventional optical systems, additional optical focusing power and/or color correction for high resolution imaging can be achieved. LGRIN represents a new design space based on recent developments in optical modeling tools to prescribe and optimize non-linear profiles that can be manufactured and reduced to practice only recently utilizing a nanolayered films material approach. Because Gradient Index lenses have been known for quite some time, the failure of industry to realize the benefits to be gained by adding or substituting conventional optics with LGRIN-based optics is telling in the non-obvious nature of the present invention. One specific reason that GRIN lenses have not been used in optical systems as discussed herein is the limited manufacturability of conventional GRIN optics as well as limited refractive index shapes that could be produced for conventional GRIN lenses that would not improve performance of the optical systems.

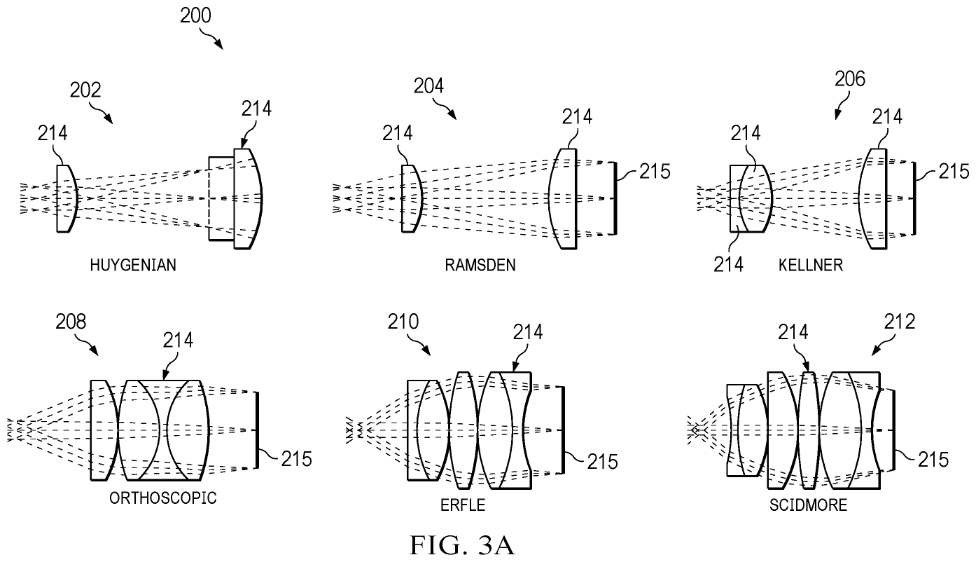

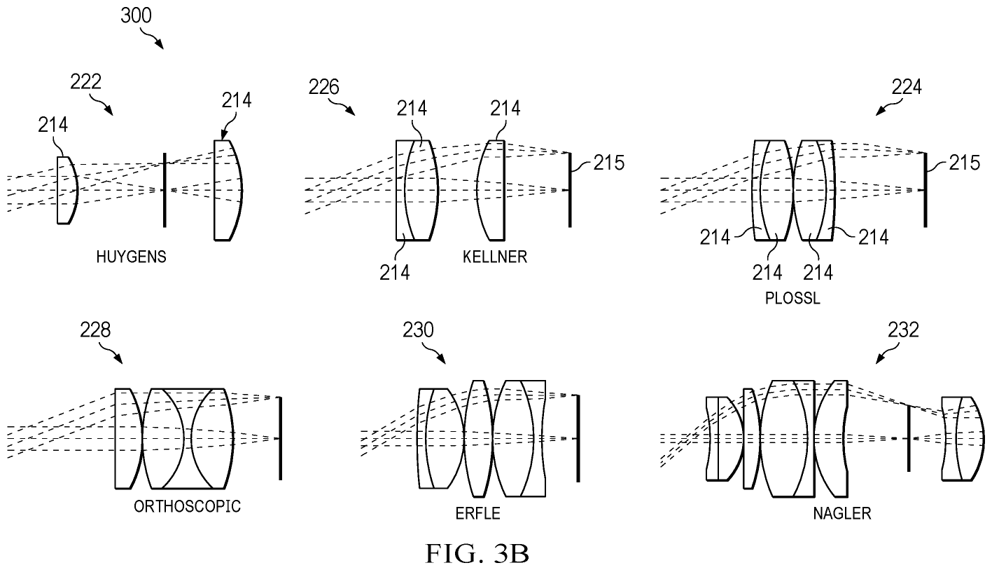

In some implementations, LGRIN lenses may be integrated into conventional optical eyepiece designs shown in FIGS. 3A and 3B. These designs include exemplary Huygenian lens forms 202, 222, an exemplary Ramsden lens form 204, exemplary Kellner lens forms 206, 226, exemplary Orthoscopic lens forms 208, 228, exemplary Erfle lens forms 210, 230, an exemplary Scidmore lens form 212, and an exemplary Nagler lens form 232. These lens forms 202-232 include a plurality of optical elements 214 each with a single index of refraction. Light rays may be passed through the optical elements 214 of the lens forms 202-232 such that rays are focused on image planes 215. The optical elements 214 may be all be formed from glass, from plastics (such as polymers), or from a mixture of glass and polymers. In some implementations, one or more LGRIN lenses may be included in the lens forms 202-232. For example, one or more LGRIN lenses may replace one or more homogenous optical elements 214. In another example, one or more LGRIN lenses may be added to the complete lens forms 202-232 as “correctors” in order to correct optical aspects of the lens form (such as improving aberrations or color correction) or to add additional magnification power.

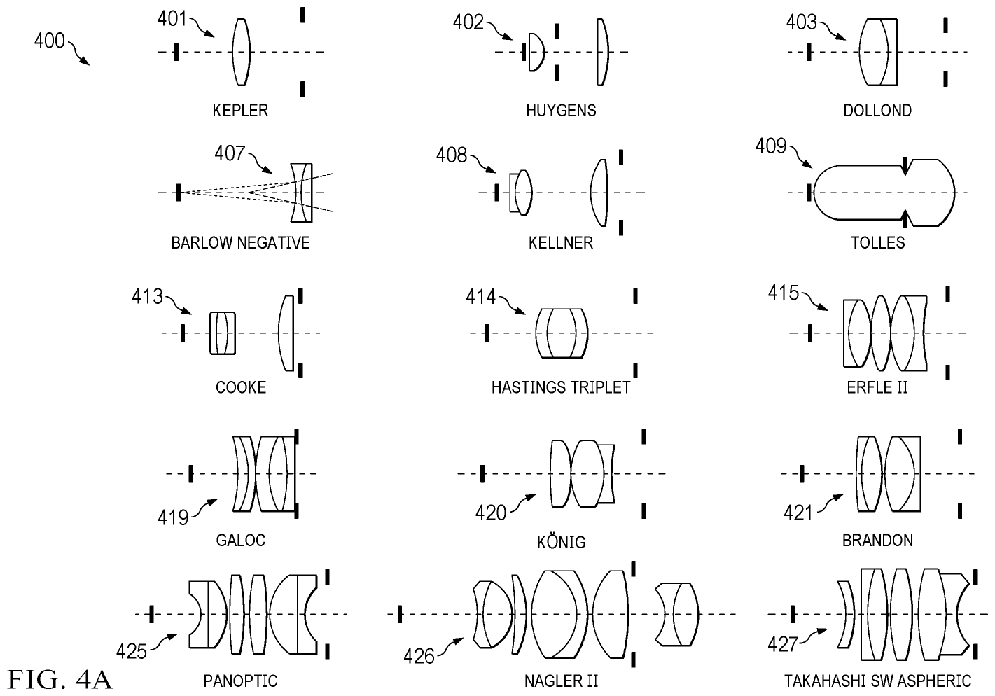

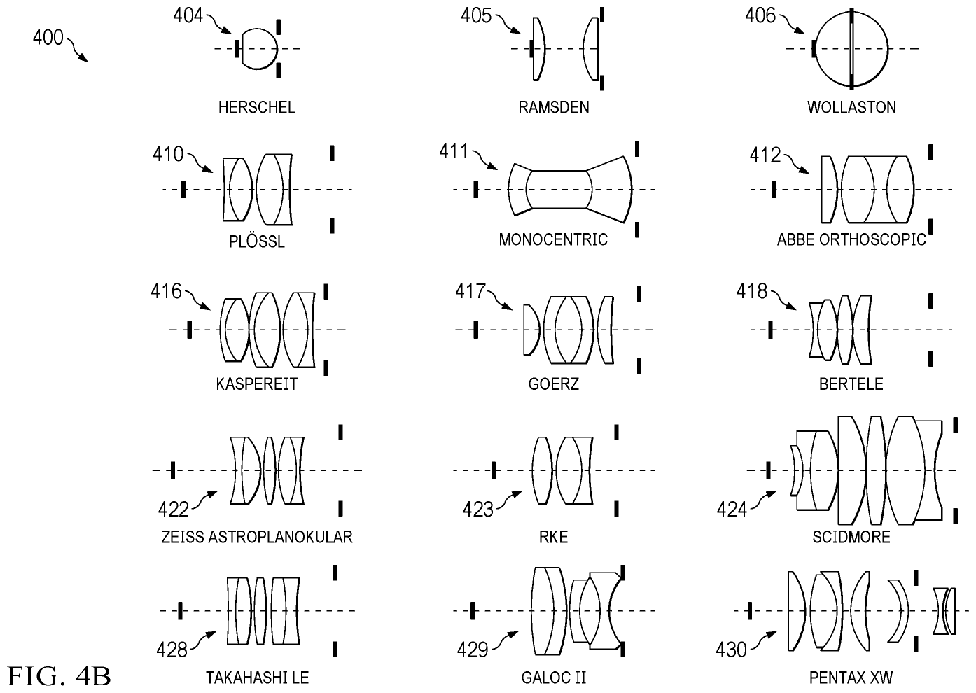

In some implementations, LGRIN lenses may be integrated into any of the conventional optical eyepiece designs shown in the chart 400 of FIG. 4, which include exemplary lens forms such as Kepler 401, Huygens 402, Dollond 403, Herschel 404, Ramsden 405, Wollaston 406, Kellner 408, Tolles 409, Plossl 410, Monocentric 411, Abbe Orthoscopic 412, Cooke 413, Hastings Triplet 414, Erfle II 415, Kaspereit 416, Goerz 417, Bertele 418, Galoc 419, Konig 420, Brandon 421, Zeiss Astroplanokular 422, RKE 423, Scidmore 424, Panoptic 425, Nagler II 426, Takahashi SW Aspheric 427, Takahashi LE 428, Galoc II 429, and Pentax XW 430. Similar to the examples given above, LGRIN lenses included in lens forms 401-430 may replace one or more homogenous optical elements or be added to the complete lens forms 401-430 as “correctors.” These LGRIN lenses may include indices of refraction that vary smoothly, discontinuously, cyclically, or with other graduated change, which might also include any, or some, homogeneous part of the GRIN profile as well. Any, all, or some of the optical lens elements in the exemplary lens forms 202-232 and 401-430 (including LGRIN lenses integrated into these lens forms) could include optical coatings of various types, for example, but not limited to Anti-Reflection, transmission enhancement or reduction, spectral filtering, bandwidth limitation, blocking, spectral notch and passband, abrasion resistance, and other types of coatings applied through various methodologies. The LGRIN lenses included in the lens forms 202-232 and 401-430 may be disposed in singlet or multiplet arrangements (such as doublets and triplets), and may be cemented to, adhered to, or airspaced from other optical elements. In some implementations, the inclusion of LGRIN lenses may provide improve optical performance while reducing the weight or length of the overall lens forms 202-232 and 401-430. The reduction of weight may be particularly beneficial because high quality eyepieces with the largest field of view are often heavy, and sometime prohibitively so, such that the inclusion of LGRIN lenses may provide improvements to other performance characteristics, including larger field of view, better resolution, more contrast, better transmission, improved color-correction, improved eye-relief, and better field-flatness, improvements which may also be associated with a reduction in weight. In some implementations, the eyepieces configured for LGRIN lenses have a field of view of 40 degrees or greater, 50 degrees or greater, or 60 degrees or greater, as the weight reduction from the LGRIN lenses replacing conventional lenses may be particularly beneficial for wide-angle lenses. In other implementations, the eyepieces configured for LGRIN lenses have a field of view of less than 40 degrees.

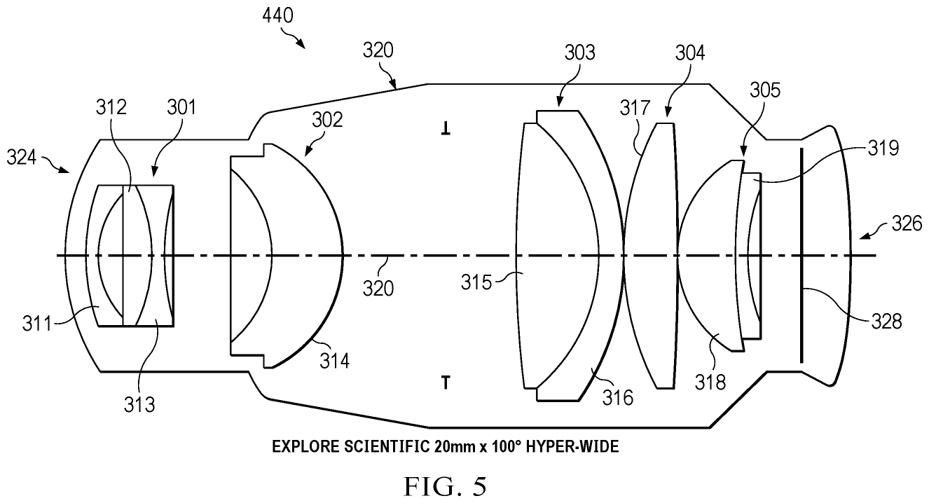

FIG. 5 depicts an exemplary wide field of view optical eyepiece 40 which would benefit from the inclusion of one or more GRIN lenses. The eyepiece 440 may include lens groups 301-305 which include one or more lenses 311-319 with homogenous indices of refraction (such as all lenses 311-319 being formed from glass). The eyepiece 440 may include a lens barrel or housing 320 which is formed around the lenses 311-319. In some implementations, the housing 320 includes mounting devices, such as flanges and offsets which may position the lenses 311-319 such that they are centered along an optical axis 322. Light rays may be passed through the eyepiece 440 from an object side 324 to an image side 326, and light may be focused on an image plane 328. In some implementations, one or more LGRIN lenses may be used to replace a lens group, for example lens group 303. In one example, a single LGRIN lens may be configured to perform the optical function of both lenses 315 and 316. In another example, two LGRIN lenses may be included to replace the two lenses 315 and 316. In other implementations, an LGRIN lens may replace a single lens within a lens group. For example, lens 312 may be replaced with an LGRIN lens, leaving the other lenses 311, 313 within lens group 301 intact. In this example, the LGRIN lens may be shaped with a surface complementary to the surfaces of the surrounding lenses (such as being formed in a doublet with lens 313 or a triplet with lenses 311 and 311). In other examples, LGRIN lenses may have a different shape as compared to the lenses they replace. In yet another embodiment, one or more LGRIN lenses may be added to the eyepiece 440 while leaving all lenses 311-319 intact and in the same configuration, for example, as a “corrector” lens. In this case, the LGRIN lens may be added to one side of the lens, such as to the right of lens 319. In all of these implementations discussed with regard to FIG. 5, the inclusion of LGRIN lenses may provide improvements to the optical performance and power of the lens, as well as providing weight savings.

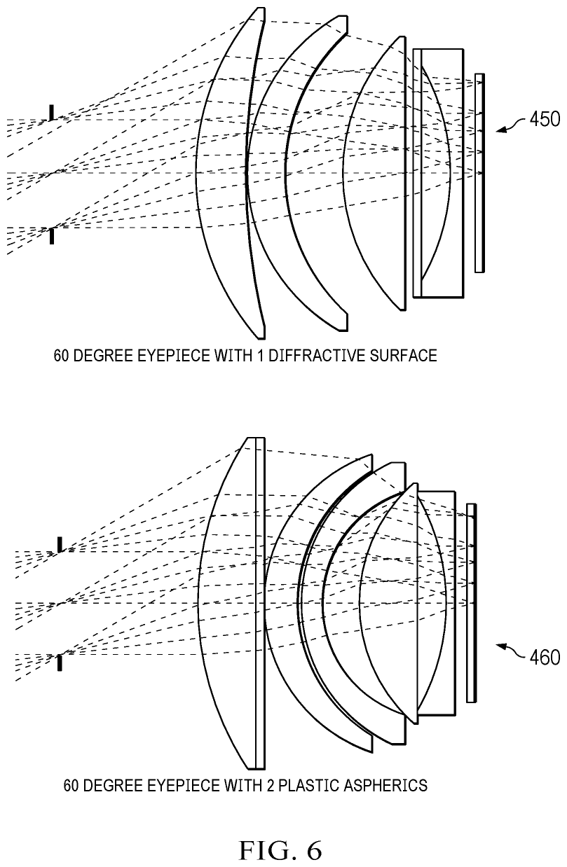

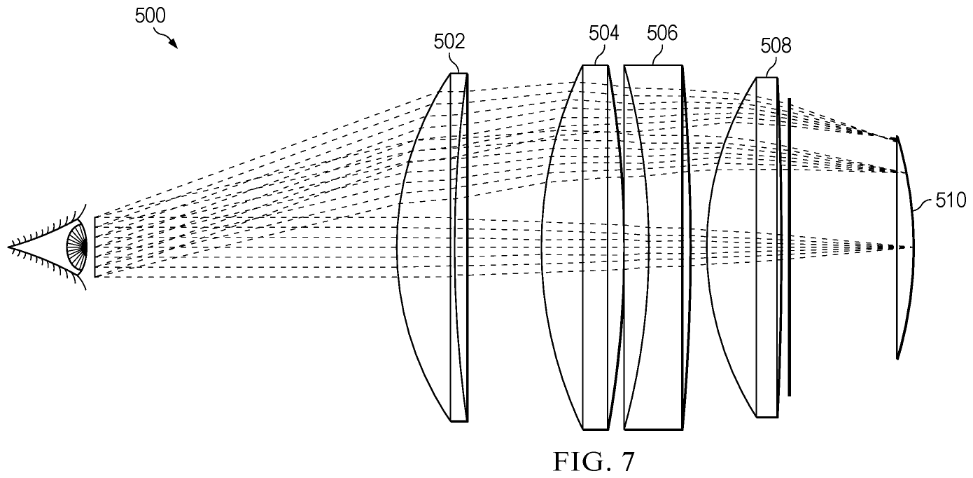

FIG. 6 depicts two exemplary wide field of view optical eyepieces 450, 460 which would benefit from the inclusion of one or more GRIN lenses. The eyepieces 450, 460 may be used with night vision applications, such as night vision goggles. Similar to the previous examples, the eyepieces 450 may include a number of lens elements with homogenous indices of refraction. In some implementations, one or more LGRIN lenses may be used to replace one or more of these optical elements. The use of LGRIN lenses may provide substantial weight savings which may be particularly beneficial for user-worn applications such as goggles.

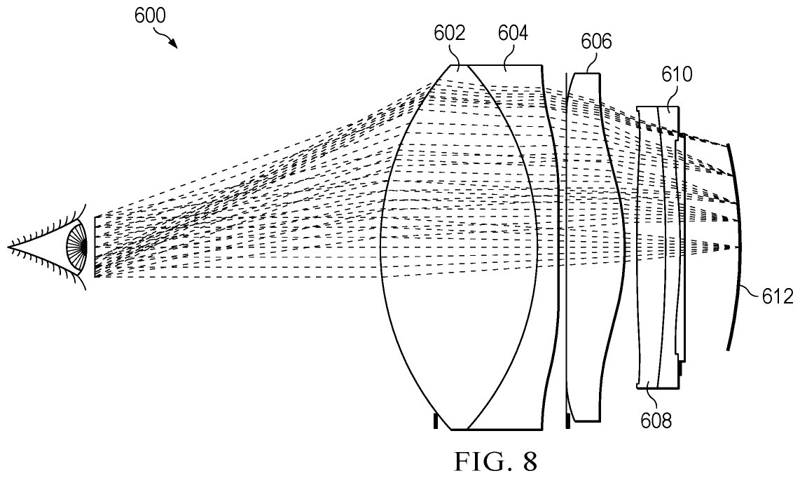

FIGS. 7 and 8 depict exemplary eyepieces 500, 600 that are configured to include one or more LGRIN lenses according to aspects of the present invention. In some implementations, eyepieces 500, 600 are configured for a night vision optical system, such as night vision goggles. Eyepiece 500 may include optical elements 502, 504, 506, 508, and 510 and eyepiece 600 may include optical elements 602, 604, 606, 608, 610, and 612 which are seen in profile. In some implementations, optical elements 502, 504, 508, and 510 each have a single index of refraction and are formed from a polymer while optical element 506 is an LGRIN lens. In some implementations, optical elements 602, 604, 608, 610, and 612 each have a single index of refraction with optical elements 602 and 604 formed from glass while optical elements 608 and 610 are formed from a polymer while optical element 606 is an LGRIN lens. In the examples of FIGS. 7 and 8, the LGRIN lenses 506, 606 have curved surfaces and indices of refraction that vary across the volume of the lenses 506, 606. The inclusion of the LGRIN lenses 506, 606 in these eyepieces 500, 600 may provide better optical performance and weight reduction, while saving costs associated expensive conventional lenses.

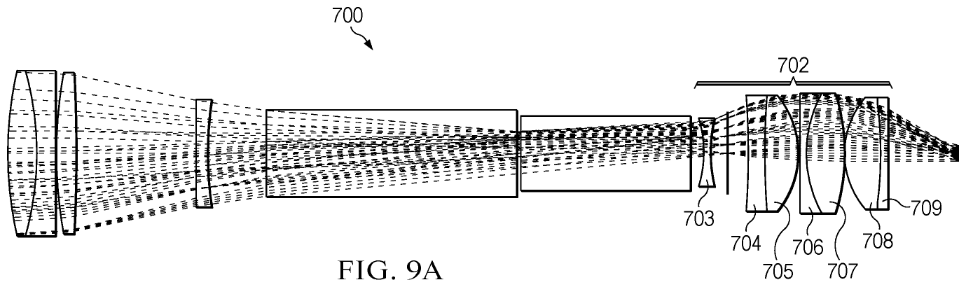

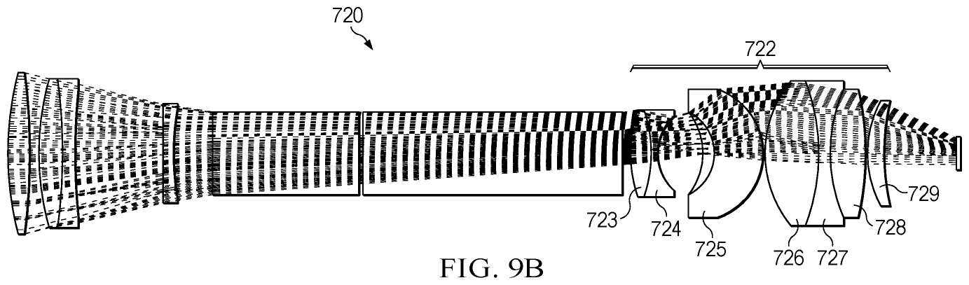

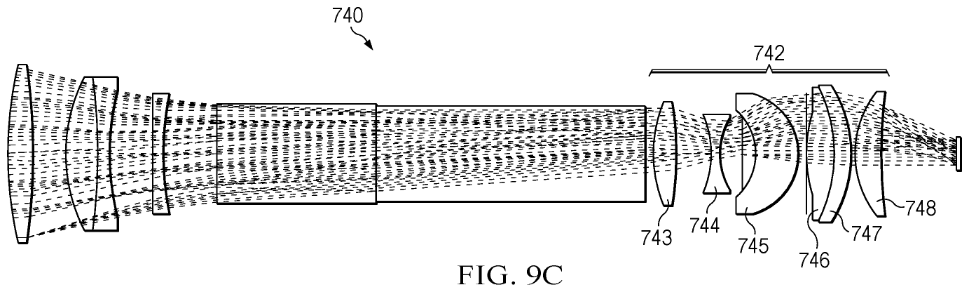

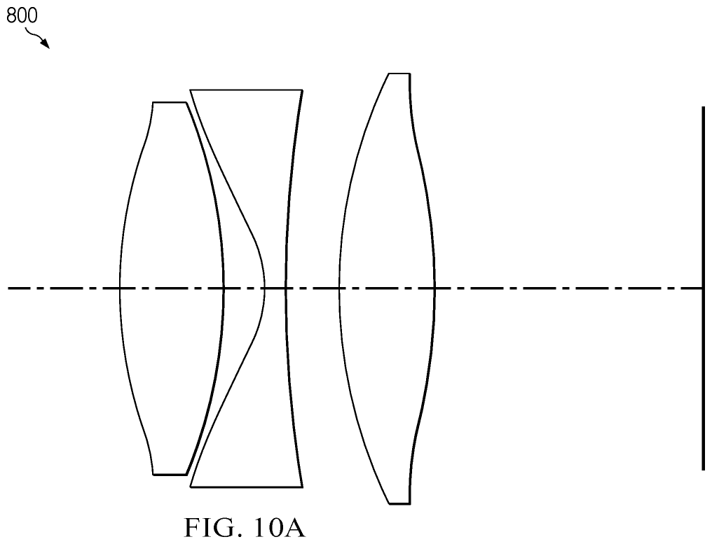

FIGS. 9A-9C show exemplary binocular designs that may be configured to include one or more LGRIN lenses according to aspects of the present invention. FIG. 9A depicts a typical binocular design 700 which may include an all-glass binocular eyepiece group 702 with homogenous glass optical elements 703-709. The other optical elements of the binocular design 700 may also be formed from glass. FIG. 9B depicts a binocular design 720 with an LGRIN binocular eyepiece group 722 including optical elements 723-729. In some implementations, optical elements 726 and 728 and formed from a polymer, optical element 727 is an LGRIN lens, and the remaining optical elements are formed from a glass. As shown in the example of FIG. 9B, the LGRIN lens 727 is formed as a triplet with optical elements 726, 728 such that the LGRIN lens 727 physically contacts the optical elements 726, 728 and extends continuously from optical element 726 to optical element 728. FIG. 9C depicts a binocular design 740 with an LGRIN binocular eyepiece group 742 including optical elements 743-748. In some implementations, optical element 746 is formed from a polymer, optical element 747 is an LGRIN lens, and the remaining optical elements are formed from glass. As shown in the example of FIG. 9C, the LGRIN lens 747 is formed as a doublet with optical elements 746 such that the LGRIN lens 747 physically contacts optical element 746.

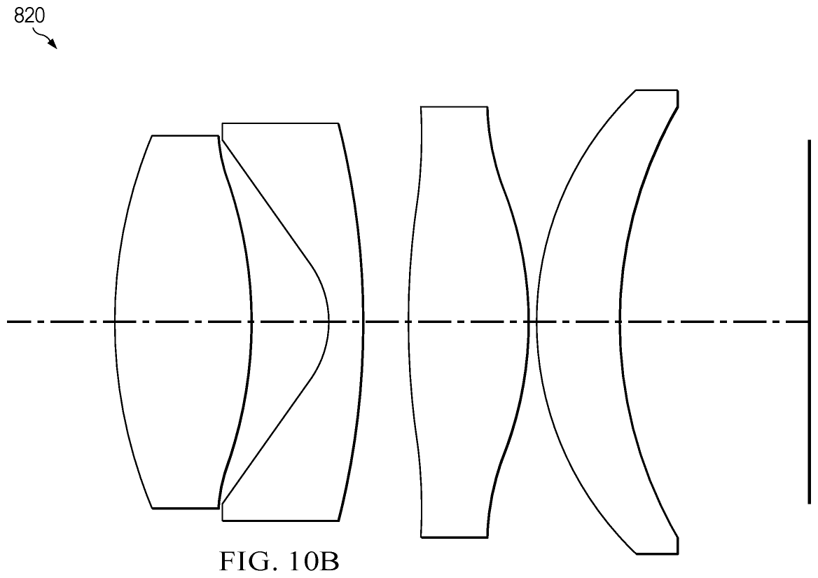

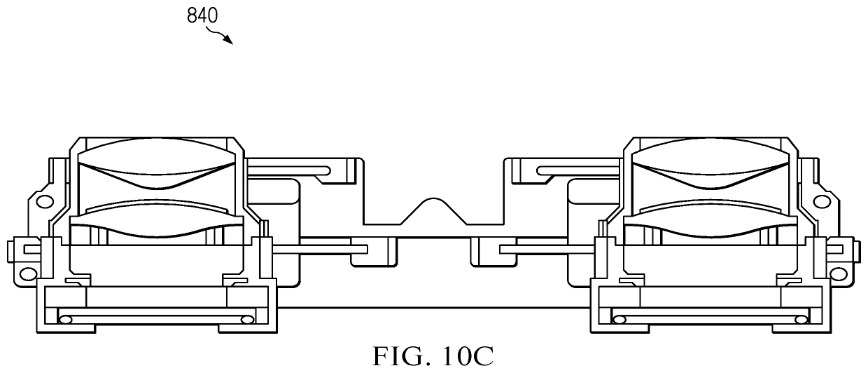

FIGS. 10A-10C depict exemplary eyepieces 800, 820, 840 that are included in U.S. Pat. No. 10,215,978 which is incorporated by reference in its entirety. The eyepieces 800, 820, 840 may be used in head-mounted displays which is another type of optical device that is ideal for configuration with one or more LGRIN lenses. In particular the eyepieces 800, 820, 840 may include homogenous asphere lenses with large field of view angle that would greatly benefit from the weight savings afforded by replacing lenses with LGRIN lenses.

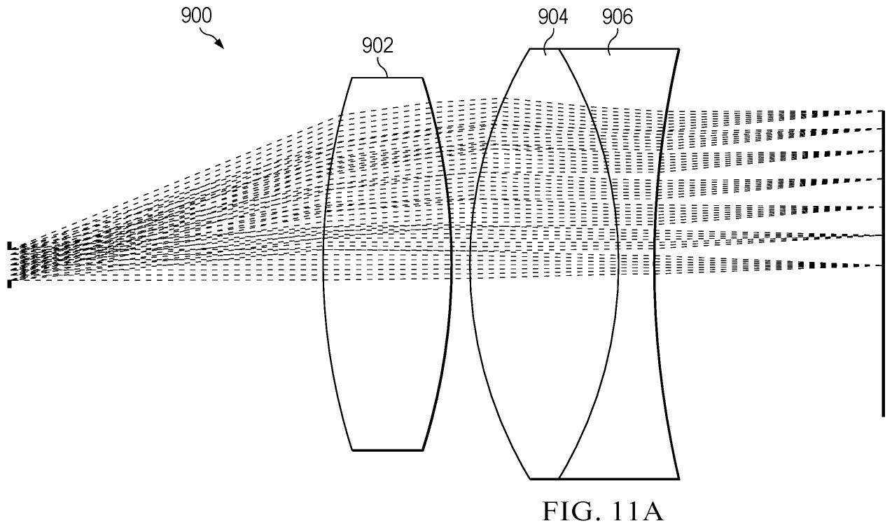

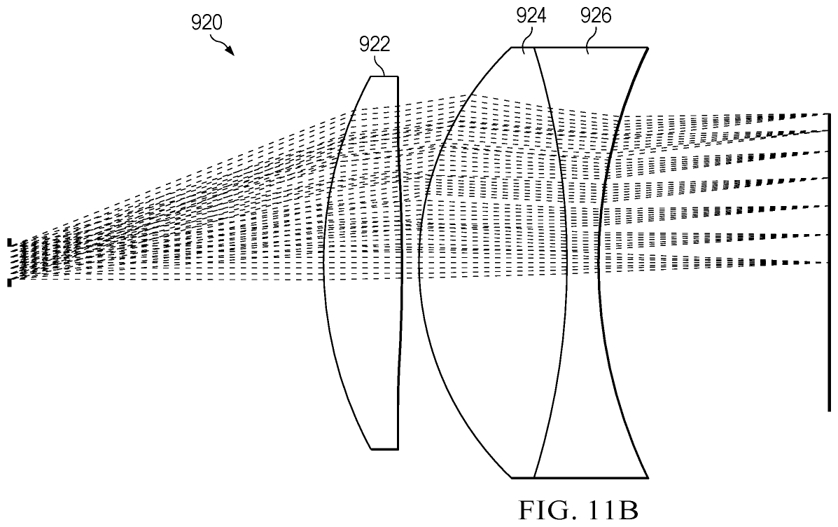

FIGS. 11A and 11B depict exemplary eyepieces 900, 920 which may be variations of the popular Edmund 28 mm RKE eyepiece. In the example of FIG. 11A, eyepiece 900 includes three optical elements: singlet lens 902 and lenses 904 and 906 which form a doublet, all of which are homogenous lenses with a single index of refraction. In some implementations, the eyepiece 900 may be reconfigured to include an LGRIN lens as in eyepiece 920 of FIG. 11B. In particular, eyepiece 920 may include an LGRIN lens 922 which replaces singlet lens 902, while lenses 924 and 926 are reoptimized based on the addition of the LGRIN lens 922. The optical performance of the eyepiece 920 is far superior to that of the eyepiece 920, as well as weighing less.

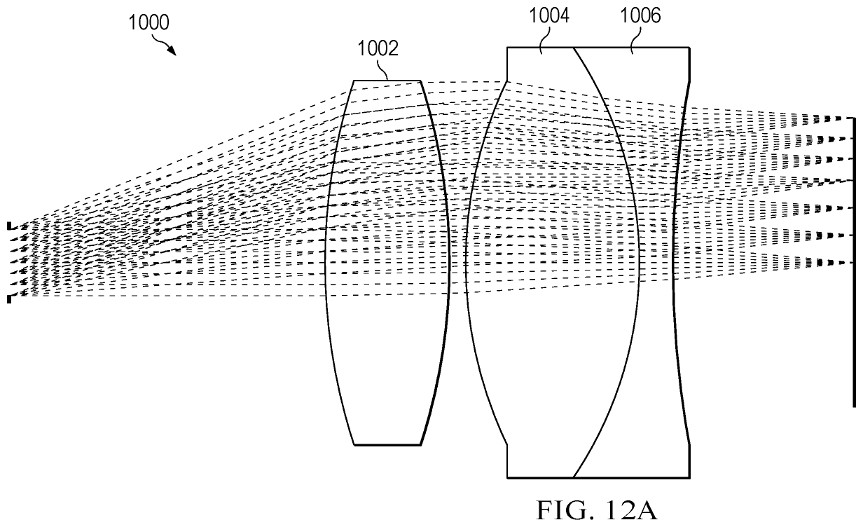

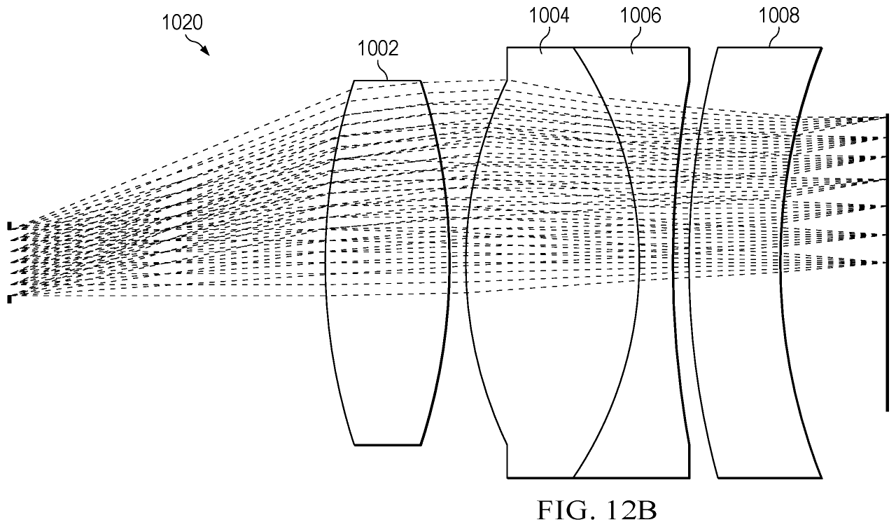

FIGS. 12A and 12B depict exemplary eyepieces 1000, 1020 which may provide further variations of the popular Edmund 28 mm RKE eyepiece. In the example of FIG. 12A, eyepiece 1000 includes three optical elements: singlet lens 1002 and lenses 1004 and 1006 which form a doublet, all of which are homogenous have a single index of refraction. In some implementations, the eyepiece 1000 may be reconfigured to include an LGRIN lens as in eyepiece 1020 of FIG. 12B. In particular, eyepiece 1020 may include the same lenses 1002, 1004, 1006 which are unchanged, as well as a “corrector” LGRIN lens 1008 which is added to the end of the eyepiece 1020. As shown by the ray trace, the addition of the corrector LGRIN lens 1008 shortens the focal length of the eyepiece 1020 as well as improving optical performance.

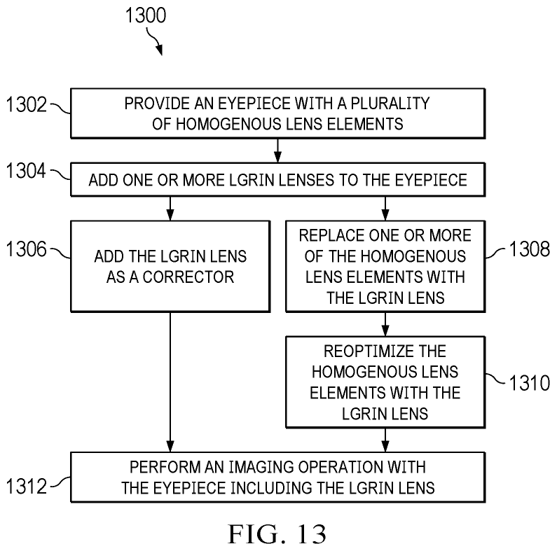

FIG. 13 illustrates an exemplary method for integrating one or more LGRIN lenses with an eyepiece as shown in FIGS. 3-12B. In some implementations, the integration of the one or more LGRIN lenses may provide improved optical performance as well as reducing the weight of the eyepiece.

The method 1300 may begin at step 1302 to provide an eyepiece with a plurality of homogenous lens elements. The eyepiece may be configured for use in a telescope, microscope, night vision equipment, binoculars, or head-mounted displays. In some implementations, the eyepiece is configured for use with a human eye, while in other implementations, the eyepiece is configured for use with imaging electronics, such as an electronic sensor. The eyepiece may be a well-known design and may have homogenous lens elements that have spherical or aspherical surfaces. The plurality of homogenous lens elements may be formed from glass, plastics, composites, or other materials.

The method 1300 may include step 1302 to add one or more LGRIN lenses to the eyepiece. In some embodiments, the one or more LGRIN lenses are added by replacing or more of the homogenous lens elements with the LGRIN lens as in step 1308. In this case, the method 1300 may proceed with step 1310 to reoptimize the homogenous lens elements to accommodate the added LGRIN lens, as shown by the comparison of FIGS. 11A and 11B.

The one or more LGRIN lenses may also be added as corrector lenses as in step 1306. The addition of the one or LGRIN lenses in this way may improve optical performance without the step of readjusting the homogenous lens elements. Optionally, the homogenous lens elements may be reoptimized to accommodate the one or more LGRIN lenses added as corrector lenses.

The method 1300 may include step 1312 to perform an imaging operation with the eyepiece including the one or more LGRIN lenses added in step 1306 or 1308. This may include a user using the eyepiece to view a scene (such using the eyepiece with a telescope or night vision goggles) or to collect imaging data (for example by providing imaging data to an imaging sensor). Step 1312 may include using the one or more LGRIN lenses to correct aberrations produced by the one or more homogenous lens elements in the eyepiece.

The foregoing outlines features of several implementations so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the implementations introduced herein. One of ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72(b) to allow the reader to quickly ascertain the nature of the technical disclosure. It is submitted with the understanding that it will not be used to interpret or limit the scope or meaning of the claims.

Moreover, it is the express intention of the applicant not to invoke 35 U.S.C. § 112(f) for any limitations of any of the claims herein, except for those in which the claim expressly uses the word “means” together with an associated function.

What is claimed is:

1. An optical eyepiece, comprising:
one or more refractive homogenous optical elements having a single index of refraction; and
one or more gradient index (GRIN) lenses having an index of refraction that varies across their volume, the one or more GRIN lenses being disposed adjacent to the one or more homogenous optical elements and configured to correct aberrations produced by the one or more homogenous optical elements; and
a housing supporting the one or more homogenous optical elements and the one or more GRIN lenses.

2. The optical eyepiece of claim 1, wherein the GRIN lens includes one or more of a polymeric nanolayer gradient index (LGRIN) lens, polymer/glass nanolayered lens, and polymer lens with inorganic filler in one or more layers.

3. The optical eyepiece of claim 1, wherein the one or more GRIN lenses are configured to replace the one or more refractive homogenous optical elements.

4. The optical eyepiece of claim 1, wherein the one or more refractive homogenous optical elements and the one or more GRIN lenses are arranged in one of a Huygens, Ramsden, Kellner, Plossl, Orthoscopic, Erfle, Scidmore, Nagler, Brandon, and Cooke lens forms.

5. The optical eyepiece of claim 1, wherein the index of refraction of the one or more GRIN lenses varies smoothly from a first value at a first surface to a second value at a second surface.

6. The optical eyepiece of claim 1, wherein the one or more GRIN lenses physically contacts the one or more refractive homogenous optical elements.

7. The optical eyepiece of claim 1, wherein the eyepiece is configured for use with one of a telescope, microscope, night vision device, binoculars, and heads-up display.

8. The optical eyepiece of claim 1, further comprising an optical sensor within the housing, the optical sensor configured to receive light rays passing through the one or more refractive homogenous optical elements and the one or more GRIN lenses.

9. A method for forming and using an optical eyepiece, comprising:
providing a plurality of refractive optical elements along an optical axis, the plurality of refractive optical elements including a first optical element and a second optical element, the first optical element and the second optical element being homogenous and having single indices of refraction;
replacing the first optical element with a gradient index (GRIN) lens having an index of refraction that varies across its volume, the GRIN lens being disposed adjacent to the second optical element along the optical axis, the GRIN lens being configured to correct aberrations produced by the second optical element; and
passing light rays through the optical eyepiece.

10. The method of claim 9, wherein the GRIN lens is a polymeric nanolayer gradient index (LGRIN) lens or a layered polymeric/inorganic composite structure.

11. The method of claim 9, wherein the plurality of refractive optical elements is arranged in one of a Huygens, Ramsden, Kellner, Plossl, Orthoscopic, Erfle, Scidmore, Nagler, Brandon, and Cooke lens form.

12. The method of claim 9, wherein the index of refraction of the GRIN lens varies smoothly from a first value at a first surface to a second value at a second surface.

13. The method of claim 9, wherein the GRIN lens is positioned to physically contact the second optical element.

14. The method of claim 9, wherein the eyepiece is configured for use with one of a telescope, microscope, night vision device, binoculars, and heads-up display.

15. The method of claim 9, further comprising positioning an optical sensor configured to receive light rays passing through the GRIN lens and second optical element.

16. An optical eyepiece, comprising:
a plurality of refractive optical elements arranged along an optical axis from an object side to an image side, the plurality of refractive optical elements including:
one or more homogenous lenses having a single index of refraction; and
one or more polymeric nanolayer gradient index (LGRIN) lenses each having an index of refraction that varies across its volume, the one or more LGRIN lenses being positioned on the object side of the one or more homogenous lenses and configured to correct aberrations produced by the one or more homogenous lenses; and
a housing sized to accommodate the plurality of refractive optical elements, the plurality of refractive optical elements being mounted within the housing.

17. The optical eyepiece of claim 16, wherein the plurality of refractive optical elements is arranged in one of a Huygens, Ramsden, Kellner, Plossl, Orthoscopic, Erfle, Scidmore, Nagler, Brandon, and Cooke lens form.

18. The optical eyepiece of claim 16, wherein the index of refraction of the one or more LGRIN lenses varies smoothly from a first value at a first surface to a second value at a second surface.

19. The optical eyepiece of claim 16, wherein the eyepiece is configured for use with one of a telescope, microscope, night vision device, binoculars, Augmented Reality, Virtual Reality, and heads-up display.

20. The optical eyepiece of claim 16, further comprising an optical sensor configured to receive light rays passing through the optical eyepiece.

21. A method for forming and using an optical eyepiece, comprising:
providing a plurality of refractive optical elements along an optical axis, the plurality of refractive optical elements including a first optical element and a second optical element, the first optical element and the second optical element being homogenous and having single indices of refraction;
providing a gradient index (GRIN) lens having an index of refraction that varies across its volume as a corrector, the GRIN lens being disposed adjacent to the second optical element along the optical axis, the GRIN lens being configured to correct aberrations produced by the first and second optical elements; and
passing light rays through the optical eyepiece.

22. The method of claim 21, wherein the GRIN lens is a polymeric nanolayer gradient index (LGRIN) lens or a layered polymeric/inorganic composite structure.

23. The method of claim 21, wherein the plurality of refractive optical elements is arranged in one of a Huygens, Ramsden, Kellner, Plossl, Orthoscopic, Erfle, Scidmore, Nagler, Brandon, and Cooke lens form.

24. The optical eyepiece of claim 16, wherein the plurality of refractive optical elements are incorporated in an athermalized lens design.
